(19) United States
(12) Patent Application Publication
(10) Pub. No.: US 2019/0288290 A1
(43) Pub. Date: Sep. 19, 2019

(54) NON-AQUEOUS ELECTROLYTE SECONDARY BATTERY

(71) Applicant: SANYO Electric Co., Ltd., Osaka (JP)

(72) Inventors: Keisuke Minami, Hyogo (JP); Kazuki Takeno, Hyogo (JP); Toyoki Fujihara, Hyogo (JP); Takuya Tamagawa, Hyogo (JP)

(73) Assignee: SANYO Electric Co., Ltd., Osaka (JP)

(21) Appl. No.: 16/254,974

(22) Filed: Jan. 23, 2019

(30) Foreign Application Priority Data
Mar. 13, 2018 (JP) 2018-045664

(51) Int. Cl. H01M 4/62; H01M 4/36; H01M 10/0525

(52) U.S. Cl. CPC H01M 4/628; H01M 10/0525; H01M 4/366

(57) ABSTRACT

A non-aqueous electrolyte secondary battery of one example according to an embodiment has an output of 1,000 W or more. An electrode body includes a protective layer which contains an insulating inorganic compound and which is provided on at least one surface of a positive electrode, a negative electrode, and a separator, and has a heat capacity per unit battery capacity of 16 J/K·Ah or more. The positive electrode has a surface resistance of 0.5 to 40Ω.

### CROSS REFERENCE TO RELATED APPLICATIONS

The present invention application claims priority to Japanese Patent Application No. 2018-045664 filed in the Japan Patent Office on Mar. 13, 2018, the entire contents of which are incorporated herein by reference.

### BACKGROUND OF THE INVENTION

### Field of the Invention

The present disclosure relates to a non-aqueous electrolyte secondary battery.

### Description of Related Art

Non-aqueous electrolyte secondary batteries, such as a lithium ion secondary battery, have been widely used for mobile electronic apparatuses, such as a video camera, a mobile phone, and a notebook personal computer. In addition, a lithium ion secondary battery has also been used as a motor drive power source for an electric car, a hybrid car, or the like. In particular, an on-vehicle lithium ion secondary battery used for an electric car, a hybrid car, or the like is required to have a high output performance. While technical development for increase in output has been aggressively carried out, degradation in safety caused by a micro short circuit has been concerned, and hence, besides a high output performance, a high safety has also been desired.

For example, Japanese Published Unexamined Patent Application No. 2015-5355 (Patent Document 1) has disclosed an electric storage device in which a positive electrode mixture layer has a surface resistance of 15 to 100Ω, and after a through-hole having a diameter of 1 mm is formed in a separator at room temperature and is then heated at 150° C. for 60 minutes while the periphery of the separator is fixed by a heat-resistant tape, the maximum diameter of the through-hole is smaller than 3 mm. Patent Document 1 has also disclosed that the output is improved, and at the same time, an increase in temperature when an internal short circuit occurs can be suppressed.

In Japanese Patent No. 5279137 (Patent Document 2), a lithium ion secondary battery having an output density of 1,000 W/kg or more has been disclosed. The battery described above includes a positive electrode containing a lithium nickel composite oxide represented by a general formula: Li₁₋ₐNiₓMn_{y}M_{z}O₂ (in the formula, M is at least one element selected from the group consisting of Ti, Cr, Fe, Co, Cu, Zn, Al, Ge, Sn, Mg, and Zr, and 0.4≤a≤0.6, x+y+z=1, x≥y>0, and x≥z>0 hold) when the potential of a negative electrode reaches 0.05 V; and a separator which includes a polyolefin-made resin film and a heat-resistant porous layer containing heat-resistant fine particles as a primary component and having a thickness of 3 μm.

Patent Document 2 has also disclosed that a high output lithium ion secondary battery excellent in reliability can be provided.

### BRIEF SUMMARY OF THE INVENTION

In association with an increase in output of a recent non-aqueous electrolyte secondary battery, a further improvement in safety has been desired. The related techniques disclosed in Patent Documents 1 and 2 have been still required to be improved in view of the increase in output and the improvement in safety of the battery.

A non-aqueous electrolyte secondary battery according to one aspect of the present disclosure is a non-aqueous electrolyte secondary battery which comprises: an electrode body including a positive electrode in which a positive electrode mixture layer is provided on a positive electrode core, a negative electrode in which a negative electrode mixture layer is provided on a negative electrode core, and a separator; and a non-aqueous electrolyte, and which has an output of 1,000 W or more. The electrode body described above further includes a protective layer which contains an insulating inorganic compound and which is provided on at least one surface of the positive electrode, the negative electrode, and the separator; the electrode body has a heat capacity per unit battery capacity of 16 J/K·Ah or more; and the positive electrode has a surface resistance of 0.5 to 40Ω.

According to the aspect of the present disclosure, a non-aqueous electrolyte secondary battery having a high output and an excellent safety can be provided. According to the non-aqueous electrolyte secondary battery of the aspect of the present disclosure, when an abnormal event, such as an internal short circuit, occurs, heat generation of the battery can be suppressed.

### BRIEF DESCRIPTION OF THE SEVERAL VIEWS OF THE DRAWINGS

FIG. 1 is a cross-sectional view of a non-aqueous electrolyte secondary battery according to one example of an embodiment;

FIG. 2 is a plan view of the non-aqueous electrolyte secondary battery according to the example of the embodiment; and

FIG. 3 is a schematic cross-sectional view of an electrode body according to one example of the embodiment.

### DETAILED DESCRIPTION OF THE INVENTION

According to intensive research carried out by the present inventors, it was found that in order to realize a non-aqueous electrolyte secondary battery having not only a high output suitable for on-vehicle application but also an excellent safety, to provide a protective layer containing heat-resistant particles between an electrode and a separator is not sufficient, and to set a surface resistance of a positive electrode and a heat capacity of an electrode body in respective specific ranges is important.

First, in order to improve the output of the battery, the resistance of each portion in the battery is required to be decreased. In general, since a positive electrode active material has a low electrical conductivity, for example, an electrically conductive material is added to a positive electrode mixture layer, or a packing density of the mixture layer is increased, so that the electrical conductivity of the mixture layer is increased. In order to realize a non-aqueous electrolyte secondary battery having a high output, such as 1,000 W or more, the surface resistance of the positive electrode is preferably low and is required to be 40Ω or less.

In the second place, in order to suppress heat generation of the battery when an abnormal event, such as an internal short circuit, occurs, the heat capacity of the electrode body is required to be increased. In a non-aqueous electrolyte secondary battery having a high output of 1,000 W or more, when a micro short circuit occurs, for example, due to intrusion of electrically conductive foreign materials, since a short circuit current is increased as compared to that in the past, and I of I²R indicating the Joule heat is increased, the calorific value is increased. Hence, in a battery having a high output, to suppress the heat generation cannot be easily performed when an abnormal event occurs, and it is estimated that only by providing the protective layer described above, an effect of suppressing the heat generation cannot be sufficiently obtained. In order to suppress the increase in temperature of the electrode body, the heat capacity of the electrode body per unit battery capacity is preferably large and is required to be set to 16 (J/K)/Ah or more.

According to one aspect of the present disclosure, in a non-aqueous electrolyte secondary battery having an output of 1,000 W or more, even if a micro short circuit occurs due to intrusion of electrically conductive foreign materials into the battery, the increase in temperature of the electrode body can be sufficiently suppressed, and a high safety can be secured.

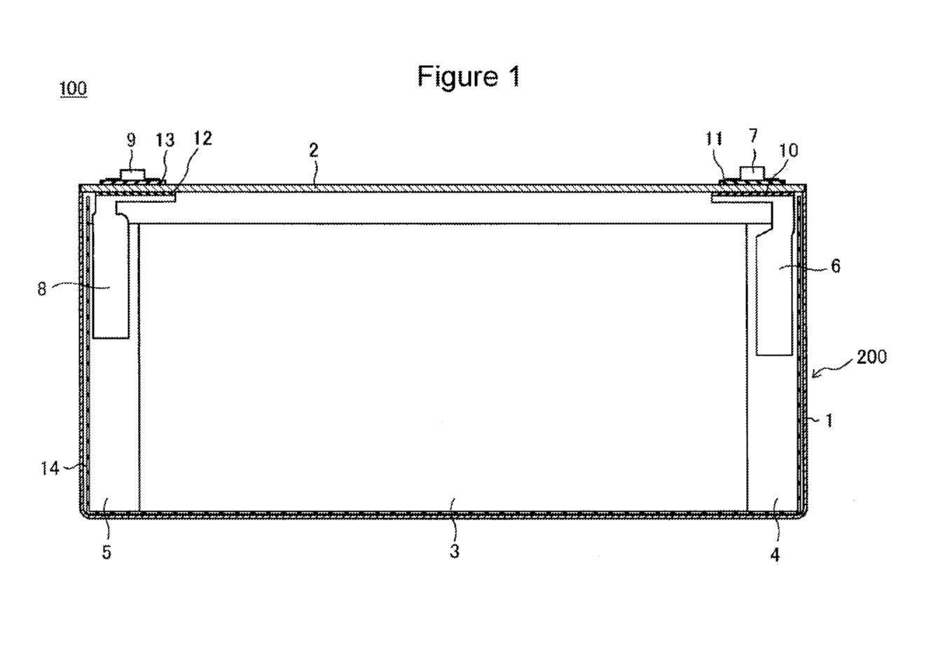

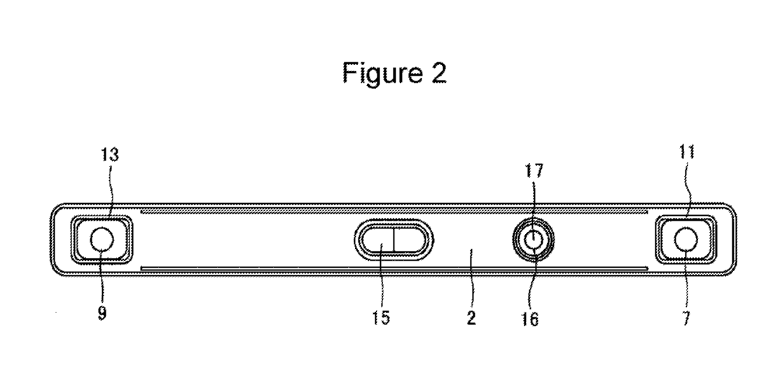

Hereinafter, with reference to the drawings, one example of the embodiment of the present disclosure will be described in detail. FIGS. 1 and 2 each show, as one example of this embodiment, a non-aqueous electrolyte secondary battery 100 which is a square battery including a square battery case 200. However, the non-aqueous electrolyte secondary battery according to the present disclosure may be a cylindrical battery including a cylindrical metal-made case, a coin-type battery including a coin-type metal-made case, or a laminate battery including an exterior body formed of a laminate sheet including a metal layer and a resin layer. In addition, as the electrode body, although an electrode body 3 having a winding structure will be described by way of example, the electrode body may have a laminate structure in which a plurality of positive electrodes and a plurality of negative electrodes are alternately laminated to each other with separators interposed therebetween.

As shown in FIGS. 1 and 2, the non-aqueous electrolyte secondary battery 100 includes a bottomed square tube exterior can 1 and a sealing plate 2 sealing an opening of the exterior can 1. The exterior can 1 and the sealing plate 2 collectively form the battery case 200. In the exterior can 1, a flat electrode body 3 in which at least one belt-shaped positive electrodes and at least one belt-shaped negative electrodes are wound with at least one belt-shaped separator interposed therebetween and a non-aqueous electrolyte are received. The electrode body 3 includes a positive electrode core exposing portion 4 formed at one axially directed end portion and a negative electrode core exposing portion 5 formed at the other axially directed end portion.

A positive electrode collector plate 6 is connected to the positive electrode core exposing portion 4, and the positive electrode collector plate 6 and a positive electrode terminal 7 are electrically connected to each other. Between the positive electrode collector plate 6 and the sealing plate 2, an internal insulating member 10 is disposed, and between the positive electrode terminal 7 and the sealing plate 2, an external insulating member 11 is disposed. A negative electrode collector plate 8 is connected to the negative electrode core exposing portion 5, and the negative electrode collector plate 8 and a negative electrode terminal 9 are electrically connected to each other. Between the negative electrode collector plate 8 and the sealing plate 2, an internal insulating member 12 is disposed, and between the negative electrode terminal 9 and the sealing plate 2, an external insulating member 13 is disposed. In addition, a winding stop tape may be adhered to the electrode body 3.

Between the electrode body 3 and the exterior can 1, an insulating sheet 14 is disposed so as to envelop the electrode body 3. In the sealing plate 2, a gas discharge valve 15 is provided which is fractured when the pressure in the battery case 200 reaches a predetermined value or more and which discharges a gas in the battery case 200 to the outside. In addition, in the sealing plate 2, an electrolyte liquid charge hole 16 is provided. The electrolyte liquid charge hole 16 is sealed by a sealing plug 17 after the non-aqueous electrolyte liquid is charged in the exterior can 1.

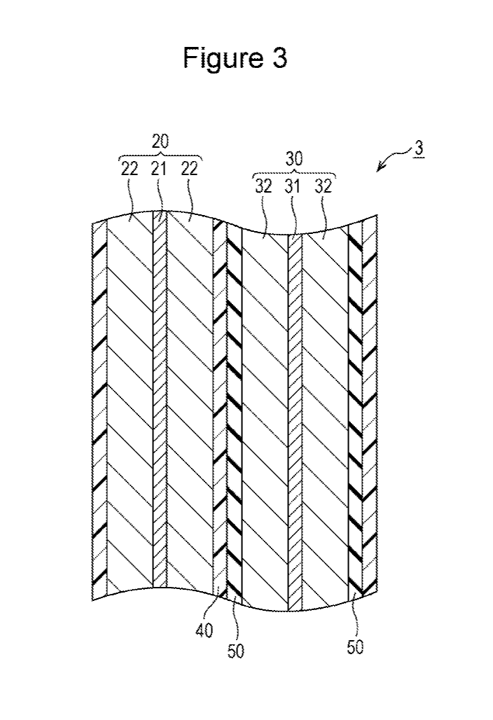

Hereinafter, with appropriate reference to FIG. 3, the electrode body 3 and the non-aqueous electrolyte forming the non-aqueous electrolyte secondary battery 100 will be described in detail. FIG. 3 is a schematic cross-sectional view of the electrode body 3 which is one example of this embodiment.

As shown in FIG. 3 by way of example, the electrode body 3 includes at least one positive electrode 20, at least one negative electrode 30, and at least one separator 40 and has a structure in which the positive electrode 20 and the negative electrode 30 are alternately laminated to each other with the separator 40 interposed therebetween. The electrode body 3 is a winding type electrode body as described above. The electrode body 3 further includes at least one protective layer 50 which is provided on at least one surface of the positive electrode 20, the negative electrode 30, and the separator 40 and which contains an insulating inorganic compound, and the electrode body 3 has a heat capacity per unit battery capacity of 16 J/K·Ah or more. In this case, the heat capacity per unit battery capacity indicates a heat capacity (J/K) of the electrode body 3 included in the non-aqueous electrolyte secondary battery 100/a battery capacity (Ah) of the non-aqueous electrolyte secondary battery 100. In addition, the surface resistance of the positive electrode 20 is 0.5 to 40Ω. The non-aqueous electrolyte secondary battery 100 using the electrode body 3 has a high output and also has an excellent safety. The non-aqueous electrolyte secondary battery 100 has an output of 1,000 W or more and is particularly preferable for on-vehicle application.

[Positive Electrode]

The positive electrode 20 includes a positive electrode core 21 and at least one positive electrode mixture layer 22 provided on the positive electrode core 21. For the positive electrode core 21, for example, foil of a metal, such as aluminum, stable in a potential range of the positive electrode 20 or a film provided with the metal mentioned above as a surface layer may be used. The positive electrode mixture layer 22 contains a positive electrode active material, an electrically conductive material, and a binding material and is preferably provided on each of two surfaces of the positive electrode core 21. The positive electrode 20 can be formed, for example, in such a way that after a positive electrode mixture slurry containing the positive electrode active material, the electrically conductive material, the binding material, and the like is applied on the positive electrode core 21, coating films thus formed are dried and then compressed, so that the positive electrode mixture layers 22 are formed on the two surfaces of the positive electrode core 21.

The surface resistance of the positive electrode 20 is 0.5 to 40Ω as described above. In order to realize a high output of 1,000 W or more, the surface resistance of the positive electrode 20 is required to be set to 40Ω or less. In addition, in order to reduce the Joule heat when an internal short circuit occurs, the surface resistance of the positive electrode 20 is also preferably 40Ω or less. In view of increase of the output and reduction in heat generated by a short circuit, although the surface resistance of the positive electrode 20 is preferably low in order to decrease R of I²R, when the productivity of the positive electrode 20 is taken into consideration, the surface resistance of the positive electrode 20 is preferably set to 0.5Ω or more. The surface resistance of the positive electrode 20 can be measured using an AP probe (distance between pins: 10 mm, pinpoint: 2.0 mm in diameter) of Loresta-EP manufactured by Mitsubishi Chemical Analytech Co., Ltd. When the protective layer 50 is formed on the surface of the positive electrode 20, the surface resistance thereof is measured in the state in which the protective layer 50 is not provided.

The positive electrode active material contains a lithium metal composite oxide as a primary component. As a metal element contained in the lithium metal composite oxide, for example, there may be mentioned Ni, Co, Mn, Al, B, Mg, Ti, V, Cr, Fe, Cu, Zn, Ga, Sr, Zr, Nb, In, Sn, Ta, and W. One example of a preferable lithium metal composite oxide is a lithium metal composite oxide containing at least one of Ni, Co, and Mn. As a particular example, for example, there may be mentioned a lithium metal composite oxide containing Ni, Co, and Mn or a lithium metal composite oxide containing Ni, Co, and Al. In addition, to a particle surface of the lithium metal composite oxide, particles of an inorganic compound, such as a tungsten oxide, an aluminum oxide, and/or a compound containing a lanthanoid, may be fixed.

The positive electrode active material preferably has a volume-based median diameter (D50) of 4 μm or less. D50 of the positive electrode active material is more preferably 2.0 to 4.0 μm and particularly preferably 2.5 to 3.5 μm. When D50 is in the range described above, a packing density of the positive electrode mixture layer 22 can be easily adjusted to a desired density which will be described below, and a decrease in surface resistance of the positive electrode 20 and an improvement in output of the battery can be easily achieved. D50 of the positive electrode active material can be measured using a laser diffraction scattering type particle size distribution meter.

As the electrically conductive material contained in the positive electrode mixture layer 22, for example, there may be mentioned a carbon material, such as carbon black, acetylene black, Ketjen black, or graphite. In particular, acetylene black is preferable. In order to decrease the surface resistance of the positive electrode 20, the content of the electrically conductive material is preferably set to 7 percent by mass or more of the total mass of the positive electrode mixture layer. When the productivity or the like of the positive electrode 20 is taken into consideration, the content described above is more preferably 7.0 to 9.0 percent by mass and particularly preferably 7.0 to 8.0 percent by mass.

As the binding material contained in the positive electrode mixture layer 22, for example, there may be mentioned a fluorine resin, such as a polytetrafluoroethylene (PTFE) or a poly(vinylidene fluoride) (PVdF); a polyacrylonitrile, a polyimide resin, an acrylic resin, or a polyolefin. Those resins each may be used together with a cellulose derivative, such as a carboxymethyl cellulose (CMC) or its salt, a polyethylene oxide (PEO), or the like. The content of the binding material is preferably 0.5 to 5 percent by mass with respect to the total mass of the positive electrode mixture layer.

In view of the decrease in surface resistance of the positive electrode 20, the packing density of the positive electrode mixture layer 22 is preferably 2.5 g/cc or more. In consideration of the productivity or the like of the positive electrode 20, the packing density is preferably 2.5 to 2.7 g/cc and particularly preferably 2.55 to 2.65 g/cc. The packing density of the positive electrode mixture layer 22 can be measured by a method described in the following example. In addition, the thickness of the positive electrode mixture layer 22 is preferably 30 μm or less and more preferably 20 to 30 μm. In this specification, the thickness of the mixture layer indicates the thickness at one side of the core unless otherwise particularly described.

As described above, the surface resistance of the positive electrode 20 can be adjusted by the particle diameter of the positive electrode active material, the packing density and the thickness of the positive electrode mixture layer 22, the type and the addition amount of the electrically conductive material added to the positive electrode mixture layer 22, and the like. On example of the structure in which the surface resistance of the positive electrode 20 is set to 40Ω or less is described below.
D50 of the positive electrode active material: 4 μm or less.
Packing density of the positive electrode mixture layer: 2.5 g/cc or more.
Content of the electrically conductive material: 7 percent by mass or more of the total mass of the positive electrode mixture layer.
Thickness of the positive electrode mixture layer: 30 μm or less.

[Negative Electrode]

The negative electrode 30 includes a negative electrode core 31 and at least one negative electrode mixture layer 32 provided on the negative electrode core 31. For the negative electrode core 31, for example, foil of a metal, such as copper, stable in a potential range of the negative electrode or a film provided with the metal mentioned above as a surface layer may be used. The negative electrode mixture layer 32 contains a negative electrode active material and a binding material and is preferably provided on each of two surfaces of the negative electrode core 31. The negative electrode 30 can be formed, for example, in such a way that after a negative electrode mixture slurry containing the negative electrode active material, the binding material, and the like is applied on the negative electrode core 31, coating films thus formed are dried and then compressed, so that the negative electrode mixture layers 32 are formed on the two surfaces of the negative electrode core 31.

As the negative electrode active material, any material may be used as long capable of reversibly occluding and releasing lithium ions, and for example, there may be used a carbon material, such as natural carbon or artificial carbon; a metal, such as Si or Sn, forming an alloy with Li; or a metal compound containing Si, Sn, or the like. As examples of the metal compound, for example, a silicon compound represented by SiOₓ (0.5≤x≤1.6) and a silicon compound represented by Li₂SiO_{(2+y)} (0<y<2) may be mentioned.

As the binding material contained in the negative electrode mixture layer 32, for example, although a fluorine resin similar to that described for the positive electrode mixture layer 22, a polyacrylonitrile, a polyimide, an acrylic resin, or a polyolefin may be used, a styrene-butadiene rubber (SBR) is preferably used. In addition, in the negative electrode mixture layer 32, for example, a CMC or its salt, a polyacrylic acid (PAA) or its salt, or a poly(vinyl alcohol) (PVA) may be contained. The content of the binding material is, for example, 0.1 to 10 percent by mass with respect to 100 parts by mass of the negative electrode active material and is preferably 0.5 to 5 percent by mass.

[Separator]

As the separator 40, a porous sheet having ion permeability and insulating properties is used. As a particular example of the porous sheet, for example, a fine porous thin film, a woven cloth, or a non-woven cloth may be mentioned. As a material of the separator 40, for example, a polyolefin, such as a polyethylene or a polypropylene, or a cellulose is preferable. The separator 40 may have either a monolayer structure or a multilayer structure.

[Protective Layer]

As described above, the protective layer 50 is an insulating layer containing an insulating inorganic compound and is provided on at least one surface of the positive electrode 20, the negative electrode 30, and the separator 40. The protective layer 50 suppresses a short circuit generated, for example, by intrusion of electrically conductive foreign materials in the electrode body 3 and improves the safety of the battery. In the example shown in FIG. 3, on two surfaces of the negative electrode 30, that is, on the surfaces of the respective negative electrode mixture layers 32, the protective layers 50 are provided. In addition, the protective layer 50 may be provided on one surface of the negative electrode 30 or may be provided on at least one of two surfaces of the positive electrode 20 or at least one of two surfaces of the separator 40.

The protective layer 50 contains the insulating inorganic compound and a binding material binding particles thereof to each other. The protective layer 50 is a porous layer in which between the particles of the inorganic compound, voids through which lithium ions are allowed to pass are formed. In this case, the insulating inorganic compound indicates particles having a volume resistivity of 10¹² Ω·cm or more measured by a voltage application type resistance meter.

As one example of the inorganic compound contained in the protective layer 50, for example, there may be mentioned a metal oxide, a metal nitride, a metal carbide, or a metal sulfide. The average particle diameter of the inorganic compound is preferably 1 μm or less and more preferably 0.1 to 1 μm. In this case, the average particle diameter indicates a volume average particle diameter measured by a light scattering method. Although not particularly limited, the thickness of the protective layer 50 is, for example, 1 to 5 μm.

As an example of the metal oxide, for example, there may be mentioned aluminum oxide (alumina), boehmite (Al₂O₃H₂O or AlOOH), magnesium oxide, titanium oxide, zirconium oxide, silicon oxide, yttrium oxide, or zinc oxide. As an example of the metal nitride, for example, there may be mentioned silicon nitride, aluminum nitride, boron nitride, or titanium nitride. As an example of the metal carbide, for example, there may be mentioned silicon carbide or boron carbide. As an example of the metal sulfide, for example, there may be mentioned barium sulfate.

In addition, the inorganic compound may be particles of a porous aluminosilicate, such as zeolite (M_{2/n}O.Al₂O₃.xSiO₂.yH₂O, M indicates a metal element, and x≥2 and y≥0 hold), a layer silicate, such as talc (Mg₃Si₄O₁₀(OH)₂), barium titanate (BaTiO₃), or strontium titanate (SrTiO₃). Among those mentioned above, in view of insulating properties, heat-resistant properties, and the like, at least one selected from aluminum oxide, boehmite, talc, titanium oxide, and magnesium oxide is preferable.

As the binding material contained in the protective layer 50, although a resin, such as a SBR, which can be applied on the negative electrode mixture layer 32 may be used, a fluorine resin which is applied on the positive electrode mixture layer 22, a polyacrylonitrile, a polyimide, an acrylic resin, or a polyolefin may be preferably used. Among those mentioned above, a polyacrylonitrile is preferable. The content of the binding material is, for example, 1 to 5 percent by mass with respect to the mass of the inorganic compound.

The heat capacity of the electrode body 3 per unit battery capacity is 16 J/K·Ah or more as described above. In order to suppress an increase in temperature when an abnormal event, such as an internal short circuit, occurs, the heat capacity of the electrode body 3 is preferably high. Hence, although the upper limit of the heat capacity of the electrode body 3 is not particularly set, in consideration of the productivity or the like of the battery, for example, a preferable range of the heat capacity is 16 to 22 J/K·Ah. The heat capacity of the electrode body 3 can be calculated in such a way that heat capacities (specific heat×mass) of components forming the electrode body 3 are calculated and then added to each other. In this specification, the heat capacity of the electrode body indicates the total heat capacity of the positive electrode, the negative electrode, the separator, and the protective layer and does not include the heat capacities of the collector plates connected to the respective core exposing portions, the winding stop tape, and the like.

The heat capacity of the electrode body 3 is determined primarily by constituent materials of the electrode body 3 and the masses thereof. When the positive electrode 20, the negative electrode 30, the separator 40, and the protective layer 50 are included, as one example of the mass of each constituent material per battery capacity at which the heat capacity per unit battery capacity is 16 J/K·Ah or more, as shown in Table 1, the mass of the positive electrode mixture layer 22 based on per unit battery capacity is 5.2 g/Ah or more, the mass of the positive electrode core 21 based on per unit battery capacity is 2.6 g/Ah or more, the mass of the negative electrode mixture layer 32 based on per unit battery capacity is 3.0 g/Ah or more, the mass of the negative electrode core 31 based on per unit battery capacity is 2.0 g/Ah or more, the mass of the separator 40 based on per unit battery capacity is 2.2 g/Ah or more, and the mass of the protective layer 50 based on per unit battery capacity is 0.6 g/Ah or more.

In this case, the mass of the positive electrode mixture layer 22 per unit battery capacity indicates the total mass (g) of the positive electrode mixture layer 22 included in the non-aqueous electrolyte secondary battery 100/the battery capacity (Ah) of the non-aqueous electrolyte secondary battery 100. The mass of the positive electrode core 21 per unit battery capacity indicates the total mass (g) of the positive electrode core 21 included in the non-aqueous electrolyte secondary battery 100/the battery capacity (Ah) of the non-aqueous electrolyte secondary battery 100. The mass of the negative electrode mixture layer 32 per unit battery capacity indicates the total mass (g) of the negative electrode mixture layer 32 included in the non-aqueous electrolyte secondary battery 100/the battery capacity (Ah) of the non-aqueous electrolyte secondary battery 100. The mass of the negative electrode core 31 per unit battery capacity indicates the total mass (g) of the negative electrode core 31 included in the non-aqueous electrolyte secondary battery 100/the battery capacity (Ah) of the non-aqueous electrolyte secondary battery 100. The mass of the separator 40 per unit battery capacity indicates the total mass (g) of the separator 40 included in the non-aqueous electrolyte secondary battery 10/0 the battery capacity (Ah) of the non-aqueous electrolyte secondary battery 100. The mass of the protective layer 50 per unit battery capacity indicates the total mass (g) of the protective layer 50 included in the non-aqueous electrolyte secondary battery 100/the battery capacity (Ah) of the non-aqueous electrolyte secondary battery 100.

TABLE 1

| CONSTITUENT MATERIAL | MASS (g/Ah |
|---|---|
| OF ELECTRODE BODY | or MORE) |
| POSITIVE ELECTRODE MIXTURE LAYER | 5.2 |
| POSITIVE ELECTRODE CORE | 2.6 |
| NEGATIVE ELECTRODE MIXTURE LAYER | 3.0 |
| NEGATIVE ELECTRODE CORE | 2.0 |
| SEPARATOR | 2.2 |
| PROTECTIVE LAYER | 0.6 |

In addition, when the mass of the positive electrode mixture layer 22 is 5.2 g/Ah or more, the mass of the positive electrode core 21 is 2.6 g/Ah or more, the mass of the negative electrode mixture layer 32 is 3.0 g/Ah or more, the mass of the negative electrode core 31 is 2.0 g/Ah or more, the mass of the separator 40 is 2.2 g/Ah or more, and the mass of the protective layer 50 is 0.6 g/Ah or more, the masses described above each being based on per unit battery capacity, the following structure is preferably formed.

The positive electrode mixture layer 22 contains a lithium transition metal composite oxide as the positive electrode active material, a carbon material as the electrically conductive material, and a resin-made binding material. As the lithium transition metal composite oxide, an oxide containing at least one of Ni, Co, and Mn is preferable, and an oxide containing Ni, Co, and Mn is more preferable. As the resin-made binding material, a poly(vinylidene fluoride) is particularly preferable.

The positive electrode core 21 is formed of aluminum or an aluminum alloy.

The negative electrode mixture layer 32 contains a carbon material as the negative electrode active material and a resin-made binding material. As the resin-made binding material, a styrene-butadiene rubber is particularly preferable.

The negative electrode core 31 is preferably formed of copper or a copper alloy.

The separator 40 is formed of a polyolefin.

The protective layer 50 contains ceramic particles and a resin-made binding material. As the ceramic particles, aluminum or boehmite is more preferable.

In addition, the resin-made binding material contained in the positive electrode mixture layer 22, the resin-made binding material contained in the negative electrode mixture layer 32, and the resin-made binding material contained in the protective layer 50 may be the same or different from each other.

[Non-Aqueous Electrolyte]

The non-aqueous electrolyte contains a non-aqueous solvent and an electrolyte salt dissolved in the non-aqueous solvent. As the non-aqueous solvent, for example, an ester, an ether, a nitrile such as acrylonitrile, an amide such as dimethylformamide, or a mixed solvent containing at least two of those mentioned above may be used. The non-aqueous solvent may include a halogen substitute in which at least one hydrogen atom of the solvent mentioned above is replaced with a halogen atom, such as a fluorine atom. As the halogen substitute, for example, there may be mentioned a fluorinated cyclic carbonate ester, such as fluoroethylene carbonate (FEC), a fluorinated chain carbonate ester, or a fluorinated chain carboxylic acid ester, such as methyl fluoropropionate (FMP). In addition, as the non-aqueous electrolyte, a solid electrolyte may also be used.

As an example of the ester mentioned above, for example, there may be mentioned a cyclic carbonate ester, such as ethylene carbonate (EC), propylene carbonate (PC), or butylene carbonate; a chain carbonate ester, such as dimethyl carbonate (DMC), ethyl methyl carbonate (EMC), diethyl carbonate (DEC), methyl propyl carbonate, ethyl propyl carbonate, or methyl isopropyl carbonate: a cyclic carboxylic acid ester, such as γ-butyrolactone (GBL) or γ-valerolactone (GVL); or a chain carboxylic acid ester, such as methyl acetate, ethyl acetate, propyl acetate, methyl propionate (MP), or ethyl propionate.

As an example of the ether mentioned above, for example, there may be mentioned a cyclic ether, such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineol, or a crown ether; or a chain ether, such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzen, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, or tetraethylene glycol dimethyl ether.

The electrolyte salt is preferably a lithium salt. As an example of the lithium salt, for example, there may be mentioned LiBF₄, LiClO₄, LiPF₆, LiAsF₆, LiSbF₆, LiAlCl₄, LiSCN, LiCF₃SO₃, LiCF₃CO₂, Li(P(C₂O₄)F₄), LiPF₆₋ₓ(CₙF₂ₙ₊₁)ₓ (1<x<6, n indicates 1 or 2), LiB₁₀Cl₁₀, LiCl, LiBr, LiI, a chloroborane lithium, a lithium lower aliphatic carboxylate, a lithium borate, such as Li₂B₄O₇ or Li(B(C₂O₄)F₂), or an imide salt, such as LiN(SO₂CF₃)₂ or LiN(C₁F₂ₗ₊₁SO₂)(CₘF₂ₘ₊₁SO₂) {l and m each indicate an integer of 0 or more}. The lithium salts mentioned above may be used alone, or at least two thereof may be used in combination. Among those mentioned above, in view of ion conductivity, electrochemical stability, and the like, LiPF₆ is preferably used. The concentration of the lithium salt is, for example, 0.8 to 1.8 moles per one liter of the non-aqueous solvent.

### EXAMPLES

Hereinafter, although the present disclosure will be further described with reference to the following examples, the present disclosure is not limited thereto.

### Example 1

[Formation of Positive Electrode Active Material]

Lithium carbonate (Li₂CO₃) and nickel cobalt manganese composite oxide (Ni_{0.35}Co_{0.35}Mn_{0.3})₃O₄ were mixed together so that the ratio of the number of moles of lithium to the total number of moles of the transition metals was 1:1. This mixture was fired at 900° C. for 20 hours in an air atmosphere, so that a positive electrode active material having a composition of LiNi_{0.35}Co_{0.35}Mn_{0.3}O₂ and a D50 of 3.0 μm was formed.

[Formation of Positive Electrode]

After the above positive electrode active material, acetylene black (AB), and a dispersion in which a poly(vinylidene fluoride) (PVdF) was dispersed in N-methyl-2-pyrrollidone (NMP) were mixed together at a solid component mass ratio of 90.9:7:2.1, so that a positive electrode mixture slurry was prepared. Next, the slurry thus obtained was applied on two surfaces of a positive electrode core (thickness: 15 μm) formed from an aluminum alloy. In this case, the slurry was not applied on two end portions of the two surfaces of the positive electrode core (the two end portions were located at the same side) along a longitudinal direction of the positive electrode core to expose the core, so that a positive electrode core exposing portion was formed. After the coating films thus obtained were vacuum dried, and NMP was removed by evaporation, rolling was performed using a rolling roller machine, followed by cutting the core into a predetermined size, so that a positive electrode was formed which had a surface resistance of 40Ω and which included positive electrode mixture layers each having a thickness of 27.5 μm and a packing density of 2.58 g/cc on the two surfaces of the positive electrode core.

[Formation of Negative Electrode]

After natural graphite, a styrene-butadiene rubber, and a carboxymethyl cellulose were mixed together at a solid component mass ratio of 98:1:1, an appropriate amount of water was added thereto, so that a negative electrode mixture slurry was prepared. The slurry thus prepared was applied on two surfaces of a copper-made negative electrode core (thickness: 8 μm). In this case, the slurry was not applied on two end portions of the two surfaces of the negative electrode core (the two end portions were located at the same side) along a longitudinal direction of the negative electrode core to expose the core, so that a negative electrode core exposing portion was formed. After the coating films thus obtained were vacuum dried, and water was removed by evaporation, rolling was performed using a rolling roller machine, followed by cutting the core into a predetermined size, so that a negative electrode which included negative electrode mixture layers on the two surfaces of the negative electrode core was formed.

[Formation of Protective Layer]

Alumina, a polyacrylonitrile, and NMP were mixed together at a mass ratio of 30:0.9:69.1 to form a protective layer slurry. After this slurry was applied on the negative electrode mixture layer, the coating film thus obtained was dried, so that protective layers each having a thickness of 2 μm were formed on two surfaces of the negative electrode.

[Formation of Electrode Body]

By the use of the above positive electrode, the above negative electrode provided with the protective layers thereon, and separators each formed of a polyethylene/polypropylene-made fine porous film, an electrode body having a winding structure was formed. In this case, after the above three types of members were overlapped with each other so that the core exposing portions of the same type electrodes were directly overlapped with each other, the different core exposing portions protruded opposite to each other with respect to the winding direction, and the separators were each provided between the positive electrode mixture layer and the negative electrode mixture layer, the three types of members were then wound by a winding machine. An insulating winding stop tape was adhered to the outermost surface, and the three types of member thus wound was compressed to have a flat shape, so that a flat electrode body having a heat capacity of 16.2 J/K·Ah was formed.

In the electrode body, an aluminum-made positive electrode collector plate and a copper-made negative electrode collector plate were fitted by ultrasonic welding, respectively, to a positive electrode core assemble region in which the positive electrode core exposing portions were overlapped with each other and a negative electrode core assemble region in which the negative electrode core exposing portions were overlapped with each other.

[Preparation of Non-Aqueous Electrolyte]

Ethylene carbonate (EC), ethyl methyl carbonate (EMC), and diethyl carbonate (DEC) were mixed together at a volume ratio (25° C., one atmospheric pressure) of 3:3:4, so that a mixed solvent was formed. To this mixed solvent, LiPF₆ was added to have a concentration of 1 mole/L, and 0.3 percent by mass of vinylene carbonate (VC) was further added with respect to the mass of this non-aqueous electrolyte, so that a non-aqueous electrolyte liquid was prepared.

[Formation of Battery]

After the electrode body described above was covered with a polypropylene-made insulating sheet and was then inserted in a square exterior can, the positive and the negative electrode collector plates were connected to respective electrode external terminals provided in the sealing plate. Next, 38 g of the above non-aqueous electrolyte was charged in the exterior can, and an opening portion of the exterior can was sealed by a blind rivet, so that a non-aqueous electrolyte secondary battery was formed.

### Comparative Example 1

Except for that by the use of the constituent materials shown in Table 2, the surface resistance of the positive electrode was set to 83Ω, and the heat capacity of the electrode body was set to 15.7 J/K·Ah, a non-aqueous electrolyte secondary battery was formed in a manner similar to that of Example 1.

### Comparative Example 2

Except for that by the use of the constituent materials shown in Table 2, the surface resistance of the positive electrode was set to 83Ω, and the heat capacity of the electrode body was set to 14.8 J/K·Ah, a non-aqueous electrolyte secondary battery was formed in a manner similar to that of Example 1.

### Comparative Example 3

Except for that by the use of the constituent materials shown in Table 2, the surface resistance of the positive electrode was set to 6Ω, and the heat capacity of the electrode body was set to 17.7 J/K·Ah, a non-aqueous electrolyte secondary battery was formed in a manner similar to that of Example 1. In addition, the electrode body of Comparative Example 3 had no protective layer.

### Comparative Example 4

Except for that by the use of the constituent materials shown in Table 2, the surface resistance of the positive electrode was set to 12Ω, and the heat capacity of the electrode body was set to 21.2 J/K·Ah, a non-aqueous electrolyte secondary battery was formed in a manner similar to that of Example 1.

### Comparative Example 5

Except for that by the use of the constituent materials shown in Table 2, the surface resistance of the positive electrode was set to 40Ω, and the heat capacity of the electrode body was set to 15.1 J/K·Ah, a non-aqueous electrolyte secondary battery was formed in a manner similar to that of Example 1.

TABLE 2

| | | COMPAR- | COMPAR- | COMPAR- | COMPAR- | COMPAR- |
|---|---|---|---|---|---|---|
| | EXAMPLE | ATIVE | ATIVE | ATIVE | ATIVE | ATIVE |
| | 1 | EXAMPLE 1 | EXAMPLE 2 | EXAMPLE 3 | EXAMPLE 4 | EXAMPLE 5 |
| POSITIVE ELECTRODE ACTIVE | 3.0 | 3.0 | 3.0 | 8.0 | 3.0 | 3.0 |
| MATERIAL D50 | | | | | | |
| (μm) | | | | | | |
| PACKING DENSITY OF POSITIVE | 2.58 | 2.51 | 2.59 | 2.65 | 2.49 | 2.57 |
| ELECTRODE MIXTURE LAYER | | | | | | |
| (g/cc) | | | | | | |
| TYPE OF POSITIVE ELECTRODE | AB | AB | AB | AB | AB | AB |
| ELECTRICALLY CONDUCTIVE | | | | | | |
| MATERIAL | | | | | | |
| AMOUNT OF POSITIVE ELECTRODE | 7 | 7 | 7 | 6 | 7 | 7 |
| ELECTRICALLY CONDUCTIVE | | | | | | |
| MATERIAL | | | | | | |
| (PERCENT BY MASS) | | | | | | |
| THICKNESS OF POSITIVE ELECTRODE | 27.5 | 26.5 | 32.0 | 27.8 | 21.5 | 24.5 |
| MIXTURE LAYER | | | | | | |
| (μm) | | | | | | |
| MASS OF POSITIVE ELECTRODE | 5.4 | 5.3 | 5.4 | 5.8 | 6.2 | 4.8 |
| MIXTURE LAYER | | | | | | |
| (g/Ah) | | | | | | |
| MASS OF POSITIVE ELECTRODE | 2.7 | 2.4 | 2.0 | 2.7 | 4.0 | 2.6 |
| CORE | | | | | | |
| (g/Ah) | | | | | | |
| MASS OF NEGATIVE ELECTRODE | 3.1 | 2.9 | 3.3 | 3.3 | 3.8 | 2.7 |
| MIXTURE LAYER | | | | | | |
| (g/Ah) | | | | | | |
| MASS OF NEGATIVE ELECTRODE | 2.1 | 2.1 | 1.7 | 2.1 | 3.1 | 2.0 |
| CORE | | | | | | |
| (g/Ah) | | | | | | |
| MASS OF SEPARATOR | 2.2 | 2.2 | 1.9 | 3.6 | 3.4 | 2.2 |
| (g/Ah) | | | | | | |
| MASS OF PROTECTIVE LAYER | 0.7 | 0.7 | 0.6 | — | 1.0 | 0.7 |
| (g/Ah) | | | | | | |

The batteries of Example 1 and Comparative Examples 1 to 5 and the constituent materials thereof were evaluated by the following methods. The evaluation results are shown in Tables 2 and 3.

[Measurement of Surface Resistance of Positive Electrode]

By the use of Loresta-EP manufactured by Mitsubishi Chemical Analytech Co., Ltd., the surface resistance was measured. As a probe, an AP probe (distance between pins: 10 mm, pinpoint: 2.0 mm in diameter) was used.

[Measurement of Packing Density of Positive Electrode Mixture Layer]

The packing density of the positive electrode mixture layer was obtained by the following method.
(1) After an electrode plate having a size of 10 cm² was prepared by cutting, a mass A (g) and a thickness C (cm) of the electrode plate thus cut were measured.
(2) After the mixture layer was peeled away from the electrode plate thus cut, a mass B (g) and a thickness D (cm) of the core were measured.
(3) The packing density of the mixture layer was calculated from the following equation.

Packing density (g/cm³)=(A−B)/[(C−D)×10]

[Measurement of Battery Capacity]

Each battery was charged at 1 It to a battery voltage of 4.1 V and was then charged at a constant voltage of 4.1 V for 2.5 hours. Subsequently, discharge was performed at a constant current of 1 It to a battery voltage of 2.5 V, and the discharge capacity at this stage was measured. In addition, the charge and the discharge described above were each performed under room temperature conditions at 25° C., and the value of 1 It was calculated from the battery capacity.

[Measurement of Battery Output]

After each battery was charged at a current of 5 A and at a room temperature of 25° C. until the state of charge reached 50%, under the state described above, discharge was performed for 10 seconds at currents of 60, 120, 180, and 240 A, and the battery voltage at this stage was measured. The output of each battery was calculated from I-V characteristics during discharge obtained by plotting the currents and the respective battery voltages. In addition, the state of charge shifted by the discharge was returned to the original state of charge by charge performed at a constant current of 5 A.

[Micro Short Circuit Simulation Test]

After each battery was charged at a current of 5 A and at a room temperature of 25° C. until the state of charge reached 100%, the battery was left at 65° C. for 3 hours. Subsequently, a stainless steel-made nail having a diameter of 1.0 mm and a tip angle of 30° C. was stabbed in a central portion of a side surface of the battery at a rate of 0.1 mm/s until a voltage drop or a temperature increase was observed, and the behavior thereafter was observed.

TABLE 3

| | | COMPAR- | COMPAR- | COMPAR- | COMPAR- | COMPAR- |
|---|---|---|---|---|---|---|
| | | ATIVE | ATIVE | ATIVE | ATIVE | ATIVE |
| | EXAMPLE 1 | EXAMPLE 1 | EXAMPLE 2 | EXAMPLE 3 | EXAMPLE 4 | EXAMPLE 5 |
| SURFACE RESISTANCE OF | 40 | 83 | 83 | 6 | 12 | 40 |
| POSITIVE ELECTRODE | | | | | | |
| (Ω) | | | | | | |
| BATTERY CAPACITY | 5.00 | 5.17 | 5.16 | 5.50 | 4.00 | 5.00 |
| (Ah) | | | | | | |
| HEAT CAPACITY OF | 81.1 | 81.1 | 76.4 | 97.5 | 84.9 | 75.6 |
| ELECTRODE BODY | | | | | | |
| (J/K) | | | | | | |
| HEAT CAPACITY OF | 16.2 | 15.7 | 14.8 | 17.7 | 21.2 | 15.1 |
| ELECTRODE BODY | | | | | | |
| (J/K · Ah) | | | | | | |
| OUTPUT | 1000 | 960 | 885 | 850 | 880 | 1000 |
| (W) | | | | | | |
| BEHAVIOR IN MICRO | DISCHARGE | INTERNAL | INTERNAL | DISCHARGE | DISCHARGE | INTERNAL |
| SHORT CIRCUIT | | COMBUSTION | COMBUSTION | | | COMBUSTION |
| SIMULATION | | | | | | |

As apparent from Tables 2 and 3, according to the battery of Example 1 in which the surface resistance of the positive electrode was set to 40Ω or less, and the heat capacity of the electrode body per unit battery capacity was set to 16 J/K·Ah or more, a high output of 1,000 W or more can be obtained, and even when a micro short circuit occurs, an abnormal event is ended only with discharge, so that a high safety can be obtained.

The reasons for this are believed as described below. When the surface resistance of the positive electrode is low, the resistance of the entire battery can be decreased, and as a result, the output is increased. However, when the output is increased, if a micro short circuit occurs, a short circuit current is increased, and the calorific value is increased. In the battery of Example 1, since the surface resistance of the positive electrode is low, the output is high, and the calorific value in a micro short circuit is increased; however, since the heat capacity of the electrode body is increased, the increase in temperature of the electrode body is suppressed, and without a significant increase in battery temperature, an abnormal event is ended only with discharge. On the other hand, according to the battery of Comparative Example 5, since the heat capacity of the electrode body is small as compared to that of Example 1, it is believed that the increase in temperature of the electrode body cannot be suppressed, and as a result, internal combustion occurs. In addition, since the surface resistance of the positive electrode of the battery of Comparative Example 1 is high as compared to that of the battery of Example 1, it is believed that the heat generation in a micro short circuit is increased, and as a result, internal combustion occurs. Since the surface resistance of the positive electrode of the battery of Comparative Example 2 is high as compared to that of the battery of Example 1, and in addition, since the heat capacity of the electrode body is small, as is the case of the batteries of Comparative Examples 1 and 5, internal combustion occurs. According to the batteries of Comparative Examples 3 and 4, although the surface resistance of the positive electrode and the heat capacity of the electrode body are in a range in which the safety can be secured, a sufficient output cannot be obtained, and hence, those batteries are not suitably used for on-vehicle application.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A non-aqueous electrolyte secondary battery having an output of 1,000 W or more, the battery comprising:
an electrode body including a positive electrode in which a positive electrode mixture layer is provided on a positive electrode core, a negative electrode in which a negative electrode mixture layer is provided on a negative electrode core, and a separator; and
an non-aqueous electrolyte,
wherein the electrode body further includes a protective layer which contains an insulating inorganic compound and which is provided on at least one surface of the positive electrode, the negative electrode, and the separator,
the electrode body has a heat capacity per unit battery capacity of 16 J/K·Ah or more, and
the positive electrode has a surface resistance of 0.5 to 40Ω.

2. The non-aqueous electrolyte secondary battery according to claim 1,
wherein the positive electrode mixture layer contains a positive electrode active material having a volume-based median diameter of 4 μm or less and an electrically conductive material and has a packing density of 2.5 g/cc or more and a thickness of 30 μm or less, and
the content of the electrically conductive material is 7 percent by mass or more of the total mass of the positive electrode mixture layer.

3. The non-aqueous electrolyte secondary battery according to claim 1,
wherein the mass of the positive electrode mixture layer, the mass of the positive electrode core, the mass of the negative electrode mixture layer, the mass of the negative electrode cord, the mass of the separator, and the mass of the protective layer per, the masses each being based on per unit battery capacity, are 5.2 g/Ah or more, 2.6 g/Ah or more, 3.0 g/Ah or more, 2.0 g/Ah or more, 2.2 g/Ah or more, and 0.6 g/Ah or more, respectively.

4. The non-aqueous electrolyte secondary battery according to claim 2,
wherein the mass of the positive electrode mixture layer, the mass of the positive electrode core, the mass of the negative electrode mixture layer, the mass of the negative electrode cord, the mass of the separator, and the mass of the protective layer per, the masses each being based on per unit battery capacity, are 5.2 g/Ah or more, 2.6 g/Ah or more, 3.0 g/Ah or more, 2.0 g/Ah or more, 2.2 g/Ah or more, and 0.6 g/Ah or more, respectively.
